(19) United States
(12) Patent Application Publication
(10) Pub. No.: US 2012/0301050 A1
(43) Pub. Date: Nov. 29, 2012

(54) IMAGE PROCESSING APPARATUS AND METHOD

(75) Inventor: Masafumi Wakazono, Kanagawa (JP)

(73) Assignee: Sony Corporation, Tokyo (JP)

(21) Appl. No.: 13/472,604

(22) Filed: May 16, 2012

(30) Foreign Application Priority Data
May 25, 2011 (JP) 2011-117467

(51) Int. Cl. G06T 5/00

(52) U.S. Cl. 382/274

(57) ABSTRACT

There is provided an image processing apparatus including a control unit configured to control whether or not to set an amplification factor for amplifying a reflectance component of an image to a large enough value to give a painterly visual effect to the image, a separation unit configured to separate the image into an illumination component and the reflectance component, an amplification unit configured to amplify the reflectance component separated by the separation unit with the amplification factor controlled by the control unit, and a combination unit configured to combine the illumination component separated by the separation unit and the reflectance component amplified by the amplification unit.

### BACKGROUND

The present disclosure relates to an image processing apparatus and method, and more particularly, to an image processing apparatus and method which can provide an image with more various effects.

Generally, High Dynamic Range (HDR) compression processing is being considered for compression and optimization of the tonal range of an image with a wide dynamic range (for example, refer to Patent Application Publication No. 2008-104010 (corresponding U.S. Patent Application No. US2008/0187235)).

For example, Patent Application Publication No. 2008-104010 discloses a method of acquiring an image with a typical range. In the method, an image with a wide dynamic range is created from a plurality of images with different exposures, and then the image is separated into a low frequency component and a high frequency component (detail component) using a smoothing filter. The tonal range of the low frequency component is compressed, and a detail component is emphasized corresponding to the amount of the compression of low frequency component. Finally, both components after the processing are combined to acquire the image of the typical range.

Also, a method of creating an image with a typical range from a plurality of images without combining an image with a wide dynamic range is disclosed.

### SUMMARY

However, it is necessary to give different effects to an HDR compressed image as well as compress a tonal range.

Thus, the present disclosure provides an image processing apparatus and method that can give more various effects to an image by processing the tone of the image and giving different visual effects to the image.

According to an embodiment of the present disclosure, there is provided an image processing apparatus which includes: a control unit configured to control whether or not to set an amplification factor for amplifying a reflectance component of an image to a large enough value to give a painterly visual effect to the image; a separation unit configured to separate the image into an illumination component and the reflectance component; an amplification unit configured to amplify the reflectance component separated by the separation unit with the amplification factor controlled by the control unit; and a combination unit configured to combine the illumination component separated by the separation unit and the reflectance component amplified by the amplification unit.

The image processing apparatus may further include a tone compressing unit configured to compress a tone of the illumination component separated by the separation unit. Here, the separation unit may separate an image with a wide tonal range into the illumination component and the reflectance component, and the combination unit may generate an image with an optimized tonal range, by combining the illumination component with a tone compressed by the tone compressing unit and the reflectance component amplified by the amplification unit.

The image processing apparatus may further include a tone extending unit configured to extend a tone of the reflectance component separated by the separation unit with respect to the tone compression by the tone compressing unit. Here, the amplification may amplify the reflectance component with the tone extended by the tone extending unit with an amplification factor controlled by the control unit.

The image processing apparatus may further include a gain combination unit configured to generate a combined gain by combining an amplification factor corresponding to the tone compression of the tone compressing unit to extend the tone of the reflectance component separated by the separation unit and the amplification factor controlled by the control unit. Here, the amplification unit may amplify the reflectance component separated by the separation unit with the combined gain generated by the gain combination unit.

The image processing apparatus may further include an image generating unit configured to generate an image with an appropriate tonal range, by combining a plurality of images with different exposure conditions by weighting the illumination component separated by the separation unit. Here, the combination unit may combine the image, which is generated by the image generating unit and includes the illumination component separated by the separation unit as a component, with the reflectance component amplified by the amplification unit.

The control unit may set the amplification factor to a larger value when giving a painterly visual effect to the image, and may set the amplification factor to a smaller value when not giving the painterly visual effect to the image.

The control unit may set a value in accordance with a luminance value of a pixel as the amplification factor. Here, a pixel value of the illumination component may be used as the luminance value.

The control unit may set a value for each region of the image as the amplification factor.

The separation unit may separate the image into the illumination component and the reflectance component using an edge preserving smoothing filter.

The separation unit may include: an illumination component extracting unit configured to extract the illumination component from the image; and a reflectance component extracting unit configured to extract the reflectance component using the image and the illumination component extracted by the illumination component extracting unit.

The separation unit may further include a luminance component extracting unit configured to extract a luminance component from the image. The illumination component extracting unit may extract the illumination component from the luminance component extracted by the luminance component extracting unit. The reflectance component extracting unit may extract the reflectance component using the luminance component extracted by the luminance component extracting unit and the illumination component extracted by the illumination component extracting unit.

The illumination component extracting unit may round the extracted illumination component, and the reflectance component extracting unit may extract the reflectance component using the illumination component extracted by the illumination component extracting unit prior the rounding.

According to another embodiment of the present disclosure, there is provided an image processing method which includes: controlling whether or not to set an amplification factor for amplifying a reflectance component of an image to a large enough value to give a painterly visual effect to the image; separating the image into an illumination component and the reflectance component; amplifying the separated reflectance component with the amplification factor; and combining the separated illumination component and the amplified reflectance component.

According to the embodiments of the present disclosure described above, it may be controlled whether or not to set an amplification factor for amplifying a reflectance component of an image to a large enough value to give a painterly visual effect to the image. The image may be separated into an illumination component and the reflectance component. The separated reflectance component may be amplified with a controlled amplification factor, and the separated illumination component and the amplification reflectance component may be combined.

According to the embodiments of the present disclosure described above, images can be processed. Particularly, more various effects can be given to an image.

### BRIEF DESCRIPTION OF THE DRAWINGS

FIG. 1 is a block diagram illustrating an exemplary main configuration of an image processing apparatus processing a tone of an image;

FIG. 2 is a diagram illustrating an example of luminance modulation characteristics of a detail gain;

FIG. 3 is a flowchart illustrating an exemplary image processing flow;

FIG. 4 is a flowchart illustrating another exemplary image processing flow;

FIG. 5 is a block diagram illustrating another exemplary configuration of an image processing apparatus;

FIG. 6 is a flowchart illustrating further another exemplary image processing flow;

FIG. 7 is a block diagram illustrating further another exemplary configuration of an image processing apparatus;

FIG. 8 is a block diagram illustrating an exemplary main configuration of a detail generation unit;

FIG. 9 is a flowchart illustrating further another exemplary image processing flow;

FIG. 10 is a block diagram illustrating an exemplary main configuration of an imaging device; and

FIG. 11 is a block diagram illustrating an exemplary main configuration of a personal computer.

### DETAILED DESCRIPTION OF THE EMBODIMENT(S)

Hereinafter, exemplary embodiments of the present disclosure will be described in detail with reference to the accompanying drawings. Description will be made in the following sequence. 1. First Embodiment (Image Processing Apparatus), 2. Second Embodiment (Image Processing Apparatus), 3. Third Embodiment (Image Processing Apparatus), 4. Fourth Embodiment (Imaging Device), and 5. Fifth Embodiment (Personal Computer).

### 1. First Embodiment

[Image Processing Apparatus]

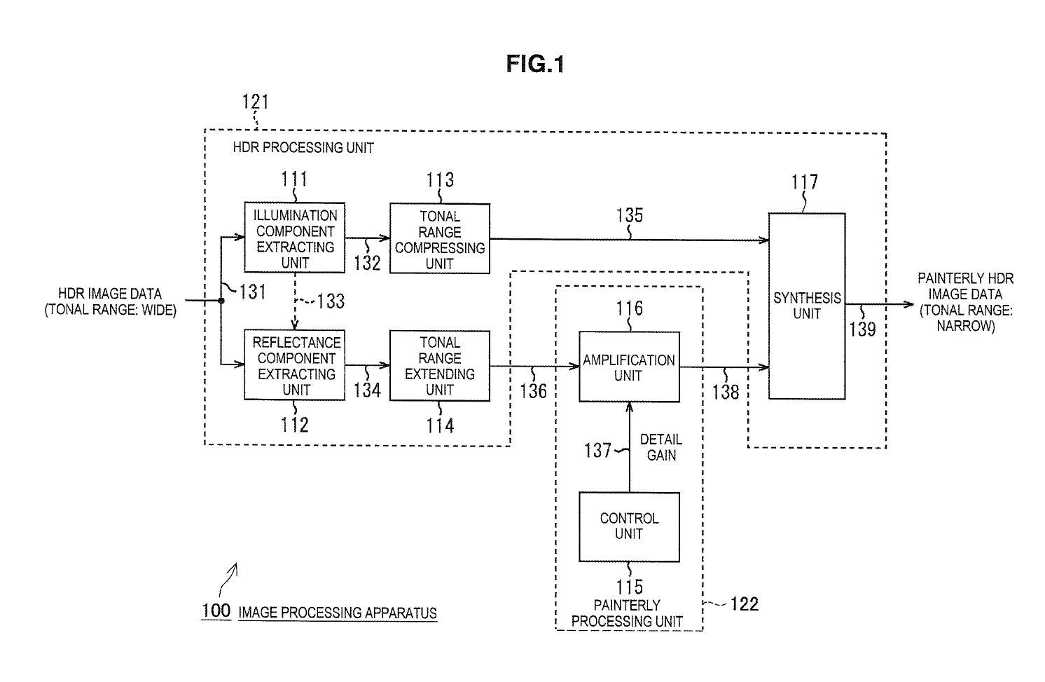

FIG. 1 illustrates an exemplary configuration of an image processing apparatus.

An image processing apparatus 100 shown in FIG. 1 may be an apparatus that performs image processing of compressing the tone of input image data and giving a painterly visual effect to the image. High Dynamic Range (HDR) image data with a wide tonal range may be input. By the above image processing, painterly HDR image data having an optimized (narrow) tonal range and provided with a painterly visual effect may be output.

As shown in FIG. 1, the image processing apparatus 100 may include an illumination component extracting unit 111, a reflectance component extracting unit 112, a tonal range compressing unit 113, a tonal range extending unit 114, a control unit 115, an amplification unit 116, and a combination unit 117.

The illumination component extracting unit 111, the reflectance component extracting unit 112, the tonal range compressing unit 113, the tonal range extending unit 114, and the combination unit 117 may constitute an HDR processing unit 121 that performs HDR processing for compressing the tone. Also, the control unit 115 and the amplification unit 116 may constitute a painterly processing unit 122 that performs painterly processing for giving a painterly visual effect to an image.

The input HDR image data (image with a wider tonal range than a normal state) may be supplied to the illumination component extracting unit 111 and the reflectance component extracting unit 112 (arrow 131)

The illumination component extracting unit 111 may extract an illumination component (also referred to as a low frequency component) by performing lowpass filter processing with respect to the input HDR image data. Also, in order to extract the illumination component, a nonlinear lowpass filter (for example, bilateral filter or filter disclosed in Patent Application Publication No. 2008-104010) that performs high-cut such that an edge component remains may be used. Also, as similar lowpass filter processing, a statistical technique (for example, mode filter or median filter) may be used in addition to the nonlinear lowpass filter. The illumination component extracting unit 111 may supply the extracted illumination component to the tonal range compressing unit 113 (arrow 132).

The tonal range compressing unit 113 may convert a luminance value of each pixel in the image data of only the input illumination component according to, for example, a lookup table (LUT) representing correspondence of input/output levels to compress the tonal range. For example, with respect to a low luminance region of the illumination component, the level may be amplified by increasing the gain to 1 or more, and with respect to a high luminance region, the level may be reduced by decreasing the gain below 1. The tonal range compressing unit 113 may supply the illumination component in which the tonal range is compressed to the combination unit 117 (arrow 135).

The illumination component extracting unit 111 may also supply the extracted illumination component to the reflectance component extracting unit 112 (arrow 133). The reflectance component extracting unit 112 may extract a reflectance component (high frequency component, also referred to as a detail component) from the input HDR image data, using the illumination component. For example, the reflectance component extracting unit 112 may acquire the reflectance component by subtracting data of the illumination component supplied from the illumination component extracting unit 111 from data of the input HDR image. Also, the reflectance component extracting unit 112, for example, may also acquire the reflectance component by dividing the data of the input HDR image by the data of the illumination component. The reflectance component extracting unit 112 may supply the extracted reflectance component to the tonal range extending unit 114 (arrow 134).

The tonal range extending unit 114 may convert the luminance value of the extracted reflectance component of each pixel according to, for example, an LUT representing correspondence of the input/output level to extend the tonal range. The tonal range extending unit 114 may amplify the reflectance component. The tonal range extending unit 114 may supply the reflectance component with the tone extended to the amplification unit 116 (arrow 136).

The control unit 115 may set a detail gain that is an amplification factor used in the amplification unit 116 (arrow 137). For example, the control unit 115 may include a storage unit, and may store a preset detail gain and then supply the preset detail gain to the amplification unit 116. Also, the control unit 115 may include an input unit, and may supply a detail gain input from the outside to the amplification unit 116. For example, the control unit 115 may include a reception unit that receives instruction of a user, and may supply a detail gain set by the user to the amplification unit 116. Also, the control unit 115 may include an operation unit, and may calculate a detail gain on the basis of information input from the outside or a user and supply the detail gain to the amplification unit 116.

The amplification unit 116 may amplify the reflectance component (detail component) supplied from the tonal range extending unit 114 into the detail gain (amplification factor) set by the control unit 115. Here, the amplification unit 116 may excessively emphasize the reflectance component to allow a perceived detail to be emphasized compared to the original. Accordingly, the texture of an image may become improved, and a painting-like special effect may be provided to the image. The amplification unit 116 may supply the amplified reflectance component to the combination unit 117 (arrow 138).

The combination unit 117 may combine image data output from the tonal range compressing unit 113 and the amplification unit 116 with respect to all pixels, and may output painterly HDR image data with the tonal range compressed as a whole result (arrow 139). For example, in the reflectance component extracting unit 112, if the reflectance component data is obtained by subtracting the illumination component data from the input image data, the combination unit 117 may perform combining processing by adding all image data output from the tonal range compressing unit 113 and the amplification unit 116. Also, in the reflectance component extracting unit 112, if the reflectance component data is obtained by dividing the illumination component data by the input image data, the combination unit 117 may perform the combining processing by multiplying all image data output from the tonal range compressing unit 113 and the amplification unit 116.

Also, the painterly HDR image data output from the combination unit 117 may undergo a process such as bit number compression.

As described above, the image processing apparatus 100 may easily compress the tonal range of image data and give a painterly visual effect to an image by excessively amplifying only the reflectance component (excessively emphasizing the detail) by the amplification unit 116 of the painterly processing unit 122 such that a perceived detail appears to be emphasized compared to the original. In other words, the image processing apparatus 100 can give more various effects to an image.

Also, when processing for compressing the tonal range and processing for giving a painterly visual effect are separately performed to extract the detail components of each, one processing may affect another processing and a desired effect may not be obtained. Specifically, since the illumination component cannot be correctly obtained, the image quality may be deteriorated. Also, instead of use of the illumination component, when a painterly visual effect is given by a method of amplifying a component extracted by a linear highpass filter, a low frequency component around an edge may also be emphasized, increasing visual deterioration of the image quality. The image processing apparatus 100 may easily give painting-like special effects to an image while suppressing the visual deterioration of the image quality, by excessively amplifying only the reflectance component extracted when the tonal range is compressed.

The amplification factor used by the amplification unit 116 may be arbitrary. However, when the amplification factor significantly increases, for example, two times, four times, and eight times, the detail may be further emphasized to strengthen the painterly visual effect given to the image.

When a stronger painterly visual effect is given to the image, the control unit 115 may set the amplification factor to a large value (for example, sufficiently larger than 1). On the other hand, a strong painterly visual effect is not intended to be given to the image, the control unit 115 may set the amplification factor to a small value (for example, approximately 1). In other words, the control unit 115 can control whether to fully perform the HDR compression processing on a subject or to give a painterly visual effect, by controlling the magnitude of the amplification factor.

When the illumination component and the reflectance component are separated using linear smoothing filter processing, a phenomenon called HALO (a halo-like artifact occurring on a contour portion) may occur on the contour, and the image quality may become undesirable (image quality is visually deteriorated). Accordingly, an edge preserving smoothing filter may be used in an illumination separation filter used by the illumination component extracting unit 111. Examples of edge preserving smoothing filters may include a bilateral filter and a method disclosed in International Patent Application Publication No. WO2009/072537 (corresponding US Patent Application No. US2010/0310189).

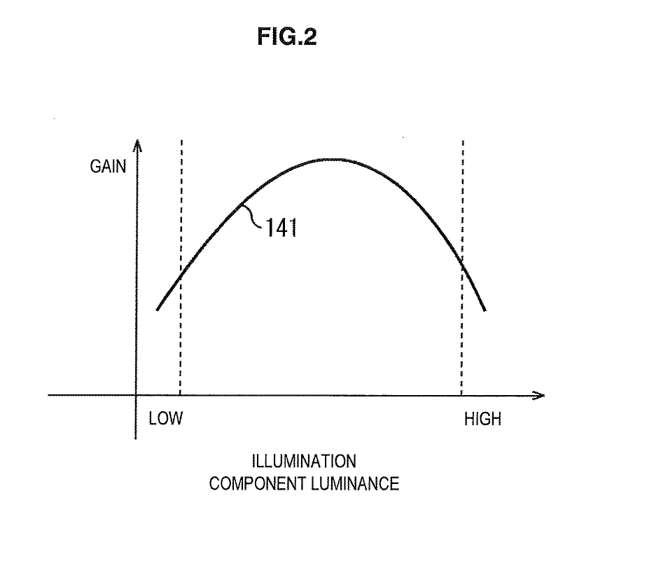

As shown in FIG. 2, the amplification factor may be set to a value corresponding to the luminance. The curve 141 shown in FIG. 2 represents an example of the luminance modulation characteristics of the detail gain. Thus, the amplification unit 116 may amplify only a signal to be emphasized as a detail by changing the amplification factor according to the luminance of the illumination component. It is possible to suppress the amplification of a high luminance portion where a fake tone due to saturation of the signal may be included in the detail component and a low luminance portion where the noise component is more included than the detail component. Accordingly, the image processing apparatus 100 can suppress visual deterioration of the image.

The amplification unit 116 may amplify the reflectance component with respect to all or only some regions of an image. For example, when a plurality of images are included like picture-in-picture, a painterly visual effect may be given only to some images (i.e., some regions). In this case, the control unit 115 may set a region to be amplified based on arbitrary information such as user's instruction, from the outside, or image analysis result, and the amplification unit 116 may amplify the reflectance component with respect to only the set region. Also, the region may be predetermined.

In this case, the reflectance component in which a painterly visual effect is given only to some regions of the image may be supplied to the combination unit 117. The combination unit 117 may acquire an image in which the painterly visual effect is given only to some regions, by combining the reflectance component and the illumination component.

Also, it is possible to control whether or not to give a painterly visual effect or not, and vary (independently set) the amplification according to the regions. For example, the control unit 115 may set the detail gains corresponding to each region, and may supply the group of the detail gains to the amplification unit 116. The amplification unit 116 may amplify the reflectance component using the detail gain corresponding to the location of a target to be processed in the supplied group of detail gains

[Flow of Image Processing]

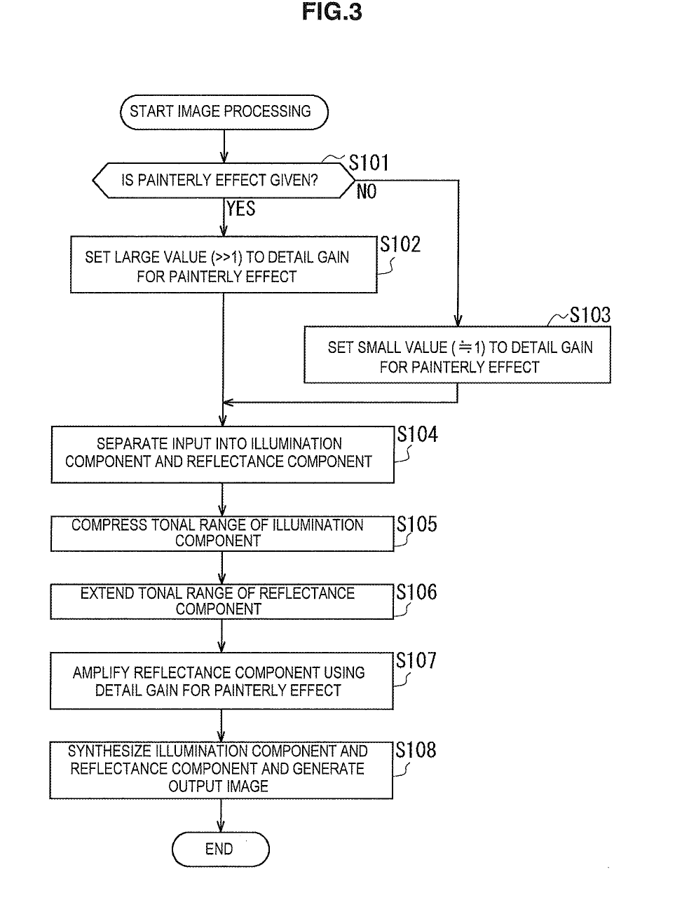

Hereinafter, an exemplary image processing flow will be described with reference to the flowchart of FIG. 3. In step S101, the control unit 115 may determine whether or not to give a painterly effect to an image on which HDR compression processing is performed. If it is determined that the painterly effect is given to the image, the control unit 115 may set a large value (sufficiently larger value than 1) to a detail gain for the painterly effect so as to excessively amplify the reflectance component in step S102.

Also, in step S101, if it is determined that the painterly effect is not given to the image, the control unit 115 may progress the processing to step S103 and set a small value (value approximate to 1) to the detail gain for the painterly effect.

In step S102 or S103, when the detail gain is set, the control unit 115 may progress the processing to step S104.

In step S104, the illumination component extracting unit 111 and the reflectance component extracting unit 112 may separate HDR image data with a wide tonal range input into an illumination component and a reflectance component.

In step S105, the tonal range compressing unit 113 may compress the tonal range of the illumination component. In step S106, the tonal range extending unit 114 may extend the tonal range of the reflectance component.

In step S107, the amplification unit 116 may amplify the reflectance component with the tonal range extended in step S106, using the detail gain for the painterly effect, set in step S102 or S103.

In step S108, the combination unit 117 may combine the illumination component with the tonal range compressed in step S105 and the reflectance component amplified in step S107 to generate an output image (HDR image data with the tonal range compressed (painterly)). The output image may be output to the outside of the image processing apparatus 100, or may be stored in a storage unit (not shown) provided in the image processing apparatus 100.

Thus, the image processing apparatus 100 can easily compress the tonal range of the image data, and can give the painterly visual effect to the image. The image processing apparatus 100 can give more various effects to the image.

[Another Flow of Image Processing]

Although it has been described above that the control unit 115 is allowed to change the detail gain for the painterly effect according to whether or not to give the painterly effect, the control unit 115 may also set the detail gain arbitrarily. For example, the detail gain may be set according to the user's instruction.

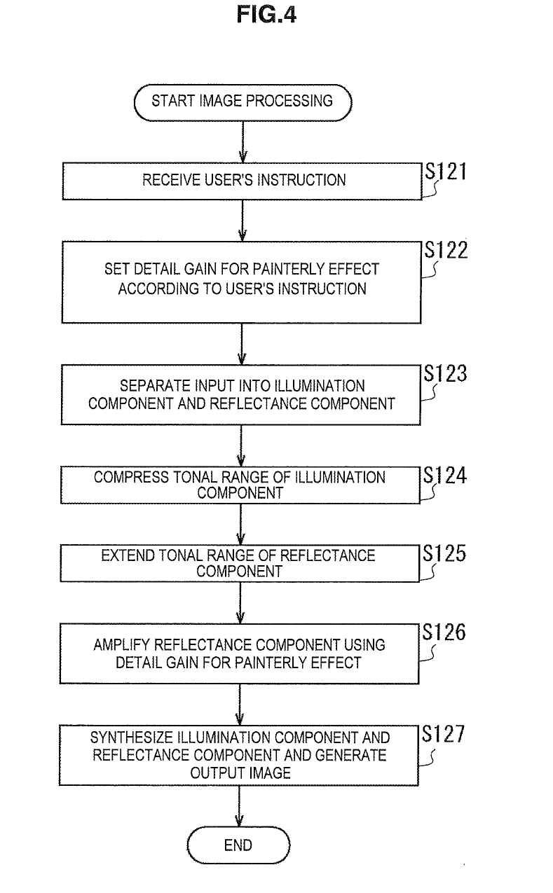

Such an exemplary image processing flow will be described with reference to the flowchart of FIG. 4. In step S121, the control unit 115 may receive a user's instruction. In step S122, the control unit 115 may set the detail gain for the painterly effect according to the user's instruction received in step S121.

When the processing of step S122 is completed, processing of steps S123 through S127 may be sequentially performed. However, since the processing is performed similarly to the processing of steps S104 through S108 of FIG. 3, a detailed description thereof will be omitted.

Thus, the image processing apparatus 100 may arbitrarily set a detail emphasis level. Accordingly, the image processing apparatus 100 may give a painterly effect to an image at a certain level.

The basis of determining the detail gain may be arbitrary, and may be performed by a method other than the user's instruction. For example, the detail gain may also be set according to setting information supplied from the outside, and the magnitude of the detail gain may be determined according to the contents of the image.

### 2. Second Embodiment

[Image Processing Apparatus]

The amplification for the painterly effect and the extension (amplification) of the tonal range with respect to the reflectance component described in the first embodiment may be realized in one-time amplification.

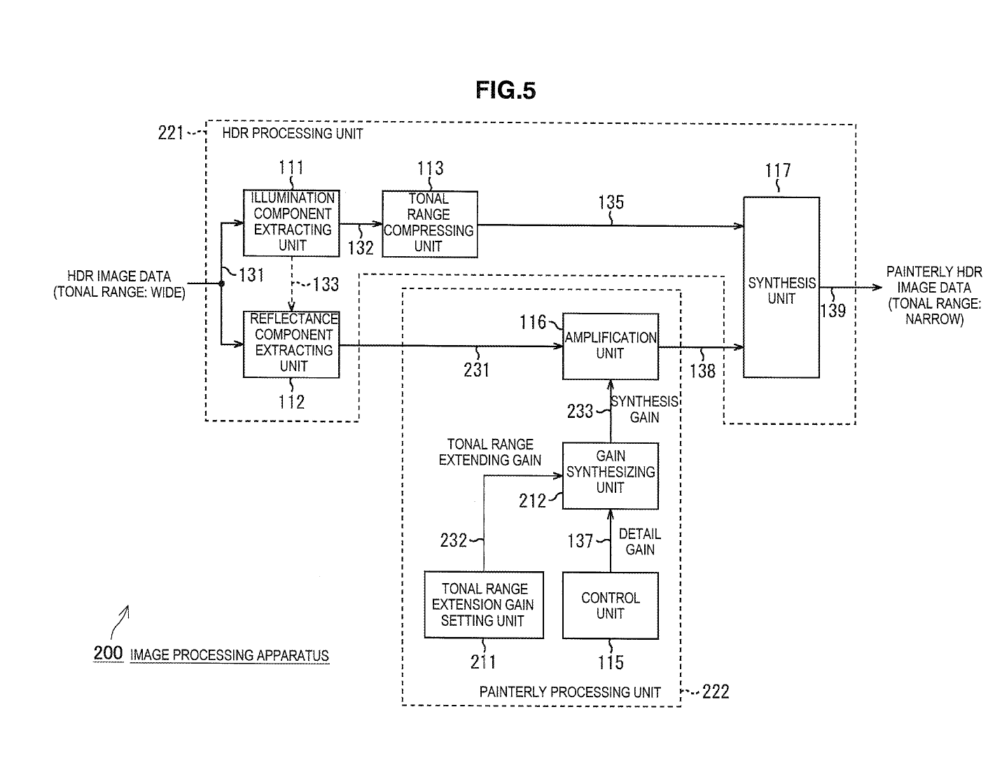

FIG. 5 is a block diagram illustrating an exemplary configuration of an image processing apparatus. An image processing apparatus 200 shown in FIG. 5 may be similar to the image processing apparatus shown in FIG. 1. The image processing apparatus 200 may perform HDR processing for compressing a tonal range with respect to an input image and a painterly processing for giving a painterly visual effect to the image.

As show in FIG. 5, in the image processing apparatus 200, the tonal range extension unit 114 may be excluded from the configuration of the image processing apparatus 100, and a tonal range extension gain setting unit 211 and a gain combination unit 212 may further be included.

In the image processing apparatus 200, an illumination component extracting unit 111, a reflectance component extracting unit 112, a tonal range compressing unit 113, and a combination unit 117 may constitute an HDR processing unit 221 that performs HDR processing, and a control unit 115, an amplification unit 116, a tonal range extension gain setting unit 211, and a gain combination unit 212 may constitute a painterly processing unit 222 that performs painterly processing.

In the image processing apparatus 200, a reflectance component extracted by the reflectance component extracting unit 112 may be supplied to the amplification unit 116 (arrow 231).

Also, the control unit 115 may supply a set detail gain to the gain combination unit 212 (arrow 137).

The tonal range extension gain setting unit 211 may set a tonal range extension gain, i.e., a gain used in the tonal range extending unit 114 of the image processing apparatus 100, and may supply the gain to the gain combination unit 212 (arrow 232).

The gain combination unit 212 may combine the tonal range extension gain supplied from the tonal range extension gain setting unit 211 and the detail gain supplied from the control unit 115 to generate a combined gain. The gain combination unit 212 may supply the created combined gain to the amplification unit 116 (arrow 233).

The amplification unit 116 may amplify the reflectance component supplied from the reflectance component extracting unit 112 using the combined gain supplied from the gain combination unit 212. The amplification unit 116 may supply the amplified reflectance component to the combination unit 117 to combine the reflectance component with the illumination component.

Thus, the amplification unit 116 may realize two-time amplification for extending the tonal range and emphasizing the detail component in the image processing apparatus 100 into one-time amplification. Similarly to the image processing apparatus 100, the image processing apparatus 200 may easily compress the tonal range of image data and simultaneously give a painterly visual effect to an image. The image processing apparatus 200 may give more various effects to the image.

Similarly to the first embodiment, the control unit 115 may set the detail gain as an arbitrary value on the basis of arbitrary information. Similarly to the first embodiment, the control unit 115 may also allow the detail gain to vary according to the luminance.

Similarly to the first embodiment, the reflectance component may also be allowed to be amplified only in some regions of the image, and the detail gain may also be allowed to be set according to the location in the image.

[Flow of Image Processing]

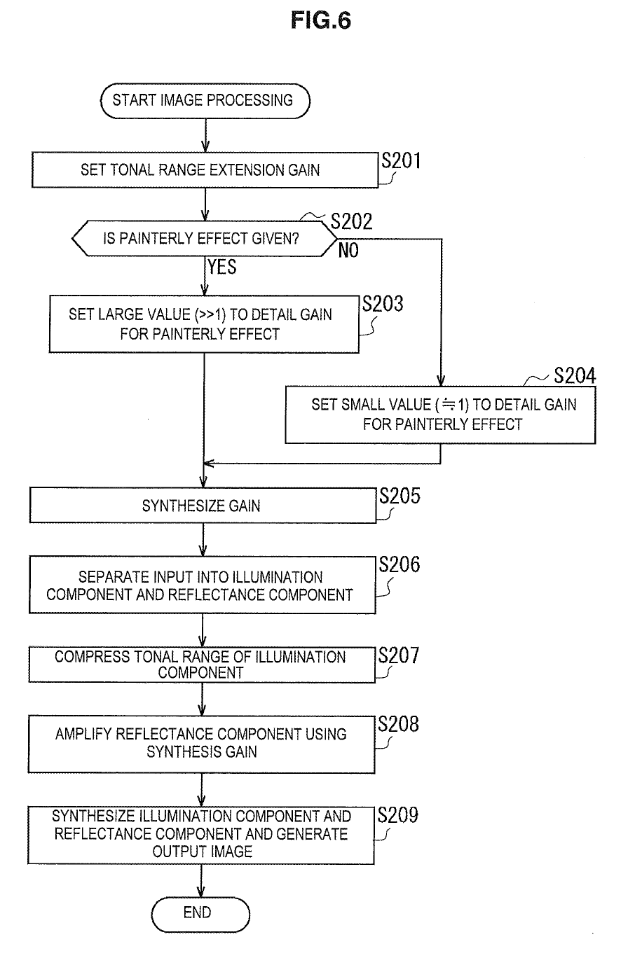

An exemplary image processing flow will be described with reference to the flowchart of FIG. 6.

In step S201, the tonal range extension gain setting unit 211 may set a tonal range extension gain on the basis of arbitrary information. In step S202, the control unit 115 may determine whether or not to give a painterly effect to an image on which HDR compression processing is performed. If it is determined that the painterly effect is given to the image, the control unit 115 may set a large value (sufficiently larger value than 1) to a detail gain for the painterly effect so as to excessively amplify the reflectance component in step S203.

Also, in step S202, if it is determined that the painterly effect is not given to the image, the control unit 115 may progress the processing to step S204 and set a small value (value approximate to 1) to the detail gain for the painterly effect.

In step S203 or S204, when the detail gain is set, the control unit 115 may progress the processing to step S205.

In step S205, the gain combination unit 212 may combine the detail gain set in step S202 or S203 with the tonal range extension gain set in step S201.

In step S206, the illumination component extracting unit 111 and the reflectance component extracting unit 112 may separate HDR image data with a wide tonal range input into an illumination component and a reflectance component.

In step S207, the tonal range compressing unit 113 may compress the tonal range of the illumination component.

In step S208, the amplification unit 116 may amplify the reflectance component extracted in step S206 using the combined gain generated in step S205.

In step S209, the combination unit 117 may combine the illumination component with the tonal range compressed in step S207 and the reflectance component amplified in step S208 to generate an output image (HDR image data with the tonal range compressed (painterly)). The output image may be output to the outside of the image processing apparatus 200, or may be stored in a storage unit (not shown) provided in the image processing apparatus 200.

By performing the above-described image processing, the image processing apparatus 200 can easily compress the tonal range of the image data, and can give the painterly visual effect to the image. The image processing apparatus 200 can give more various effects to the image.

### 3. Third Embodiment

[Image Processing Apparatus]

In addition to methods for HDR processing described in the first and second embodiments, there is a method of generating an image with an appropriate tonal range by combining a plurality of images with different exposure conditions such that the deterioration of the image quality such as excessive brightening or darkening does not occur.

For example, in a scene in which the luminance range within a view angle is wide, the precision of auto exposure processing (AE processing) may be reduced, and a main subject within the view angle may be brightened due to overexposure, or may be buried in noise or darkened due to underexposure. Accordingly, as an imaging method for acquiring an image captured with appropriate exposure conditions in such a scene, there has been known a method called “exposure bracketing,” in which a plurality of image signals are acquired by performing continuous exposures several times while varying the exposure condition.

An imaging method by which an image (wide dynamic range image) with a dynamic range wider than the output of an imaging element can be acquired using the exposure bracketing is being studied. In the imaging of the wide dynamic range image, an image captured by sufficient exposure through the exposure bracketing and an image captured by decreased exposure may be acquired, and the images may be combined to an image with a wide dynamic range. In other words, it is possible to introduce information on a tonal range with a wide luminance range that cannot be acquired from one-time exposure into the image after combination, by combining an image components acquired with a tone at a high luminance side by decreasing exposure and an image component acquired with a tone at a low luminance by increasing exposure.

For example, by the above imaging, when an image with an appropriate tonal range, which is combined such that the deterioration of the image such as brightening and darkening quality does not occur, is generated from a plurality of images with different exposure conditions, there is a method of generating HDR image data (wide dynamic range image) with a wide tonal range as described in the first and second embodiments and compressing the tonal range of the image using the tone compressing processing of HDR input as described above.

However, since the above method requires that HDR image data with a wide tonal range be generated, the amount of memory necessary for the processing may be increased.

Accordingly, there is a method of generating an image with an appropriate tonal range by combining a plurality of images with different exposure conditions such that deterioration of the image quality such as brightening or darkening does not occur, without generating the HDR image data with the wide tonal range.

In this embodiment, exemplary painterly processing in the HDR processing method will be described below.

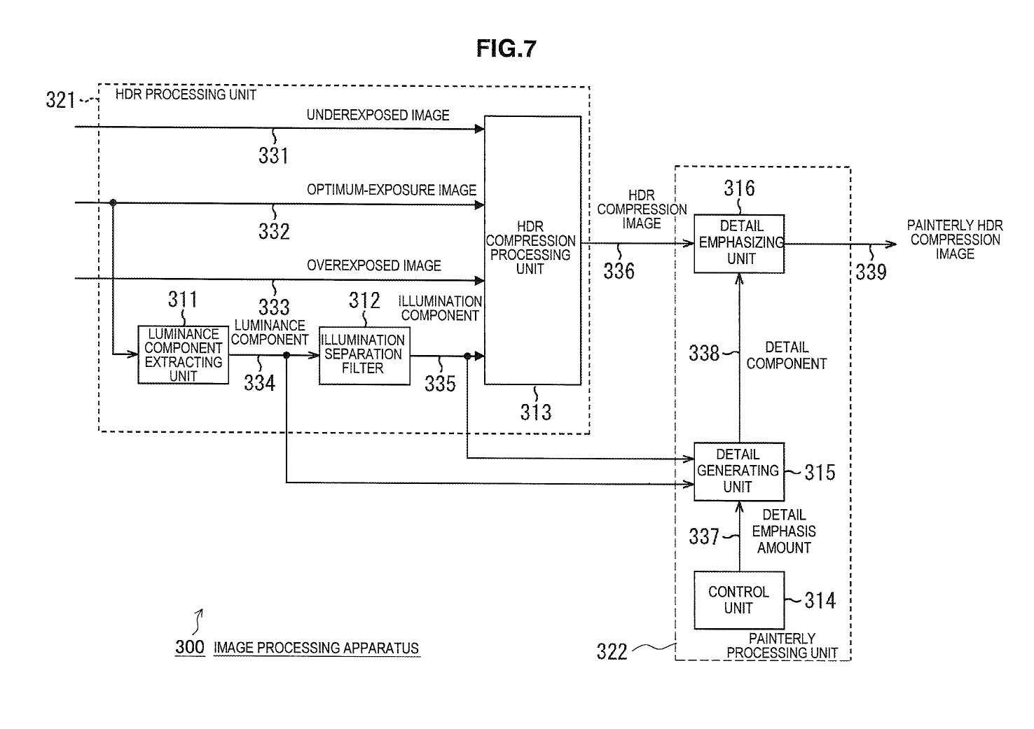

FIG. 7 is a block diagram illustrating an exemplary main configuration of an image processing apparatus. An image processing apparatus 300 shown in FIG. 7, which is basically similar to the image processing apparatus 100 of FIG. 1 and the image processing apparatus 200 of FIG. 5, may perform HDR processing for compressing the tonal range and simultaneously painterly processing for giving a painterly visual effect. However, in the case of the image processing apparatus 300, three images (an underexposed image, an optimum-exposure image, and an overexposed image) with different exposure conditions may be input instead of HDR image data with a wide tonal range.

The image processing apparatus 300 may include a luminance component extracting unit 311, an illumination separation filter 312, an HDR compression processing unit 313, a control unit 314, a detail generating unit 315, and a detail emphasizing unit 316.

The luminance component extracting unit 311, the illumination separation filter 312, and the HDR compression processing unit 313 of the configuration may constitute an HDR processing unit 321 that performs HDR processing for combining three images with different exposure conditions such that deterioration of the image quality such as brightening or darkening does not occur and generating an image with an appropriate tonal range. Also, the control unit 314, the detail generating unit 315, and the detail emphasizing unit 316 may constitute a painterly processing unit 322 that gives a painterly visual effect to the image.

As described above, an underexposed image generated by intentionally decreasing exposure below the optimum value, an optimum-exposure image generated with optimum exposure, and an overexposed image generated by intentionally increasing exposure beyond the optimum value may be input to the image processing apparatus 300. Each image may be supplied to the HDR compression processing unit 313 (arrows 331 through 333)

The optimum-exposure image may also be supplied to the luminance component extracting unit 311 (arrow 332). The luminance component extracting unit 311 may extract a luminance component from the input optimum-exposure image, and may supply the luminance component to the illumination separation filter 312 and the detail generating unit 315 (arrow 334).

Similarly to the illumination component extracting unit 111, the illumination separation filter 312 may extract an illumination component from the input luminance component by an edge preserving smoothing filter. The illumination separation filter 312 may supply the extracted illumination component to the HDR compression processing unit 313 and the detail generating unit 315 (arrow 335).

The HDR compression processing unit 313 may convert the illumination component supplied from the illumination separation filter 312 into a combination coefficient using a predetermined conversion table, and may combine the underexposed image, the optimum-exposure image and the overexposed image that are input, using the combination coefficient. More specifically, the HDR compression processing unit 313 may weight each image using the combination coefficient and add the weighted images to each other. Thus, the HDR compression processing unit 313 may generate an image (HDR compressed image) with an appropriate tonal range, which is combined such that the deterioration of the image quality such as brightening or darkening does not occur, from the underexposed image, the optimum-exposure image, and the overexposed image. This image may correspond to an HDR image with an optimized tone, in which the tone processing is performed only on an HDR image with a wide tonal range. The HDR compression processing unit 313 may supply the generated HDR compressed image to the detail emphasizing unit 316 (arrow 336). Also, the HDR compressed image may become an image that includes an illumination component as a component.

The control unit 314 may set a detail emphasis amount that is an emphasis amount of the reflectance component of the HDR compressed image for giving a painterly visual effect. The detail emphasis amount may be a gain that excessively emphasizes the detail component of the HDR compressed image. The control unit 314 may supply the detail emphasis amount to the detail generating unit 315 (arrow 337).

The detail generating unit 315 may extract the reflectance component of the luminance component of the optimum-exposure image, using the luminance component of the optimum-exposure image supplied from the luminance component extracting unit 311 and the illumination component of the luminance component of the optimum-exposure image supplied from the illumination separation filter 312. The detail generating unit 315 may operate similarly to the reflectance component extracting unit 112, and may extract the reflectance component by subtracting the illumination component from the luminance component or dividing the illumination component by the luminance component.

Also, the detail generating unit 315 may emphasize the extracted reflectance component by emphasizing the detail emphasis amount supplied from the control unit 314, and may generate the emphasized detail component. The detail generating unit 315 may supply the emphasized detail component to the detail emphasizing unit 316 (arrow 338).

The detail emphasizing unit 316 may excessively emphasize the detail of the HDR compressed image supplied from the HDR compression processing unit 313 and give a painterly visual effect by multiplying the detail component supplied from the detail generating unit 315. The detail emphasizing unit 316 may output the HDR compressed image (painterly HDR compressed image) with detail emphasized (arrow 339).

The painterly HDR image data output from the detail emphasizing unit 316 may undergo a process such as additional bit number compression.

As described above, the image processing apparatus 300 may easily combine a plurality of images with different exposure conditions such that deterioration of the image quality such as brightening or darkening does not occur to generate an image with an appropriate tonal range and simultaneously give a painterly visual effect to the image by excessively amplifying only the reflectance component (excessively emphasizing the detail) of the HDR compressed image by the detail emphasizing unit 316 of the painterly processing unit 322 such that a perceived detail appears to be emphasized compared to the original. In other words, the image processing apparatus 300 can give more various effects to the image.

Similarly to the amplification factor of the first or second embodiment, the detail emphasis amount may be arbitrary. However, when the detail emphasis amount significantly increases, for example, two times, four times, and eight times, the detail may be further emphasized to strengthen the painterly visual effect given to the image.

For example, when a stronger painterly visual effect is given to the image, the control unit 314 may set the detail emphasis amount to a large value (for example, larger than 1). On the other hand, when a strong painterly visual effect is not intended to be given to the image, the control unit 314 may set the detail emphasis amount to a small value (for example, approximate to 1). In other words, the control unit 314 can control whether to fully perform the HDR compression processing on a subject or to give a painterly visual effect by controlling the magnitude of the detail emphasis amount.

Similarly to the amplification factor of the first and second embodiments, as shown in FIG. 2, the detail emphasis amount may relate to the luminance. The curve 141 shown in FIG. 2 represents an example of the luminance modulation characteristics of the detail gain. Thus, the detail emphasizing unit 316 may amplify only a necessary part recognized as a detail by changing the detail emphasis amount according to the luminance of the illumination component. As a result, it is possible to suppress the amplification of a lowpass component without detail or a highpass component including many unnecessary noise components. Accordingly, the image processing apparatus 300 can suppress visual deterioration of the image.

Also, similarly to the first or second embodiment, the detail component may be allow to be amplified only in some regions of the image, and the detail emphasis amount may be allowed to be set according to the location in the image.

Although it has been described above that the luminance component extracting unit 311 is allowed to extract the luminance component from the optimum-exposure image, the luminance component extracting unit 311 is not limited thereto and the luminance component extracting unit 311 may extract the luminance component from the underexposed image or the overexposed image.

[Detail Generating Unit]

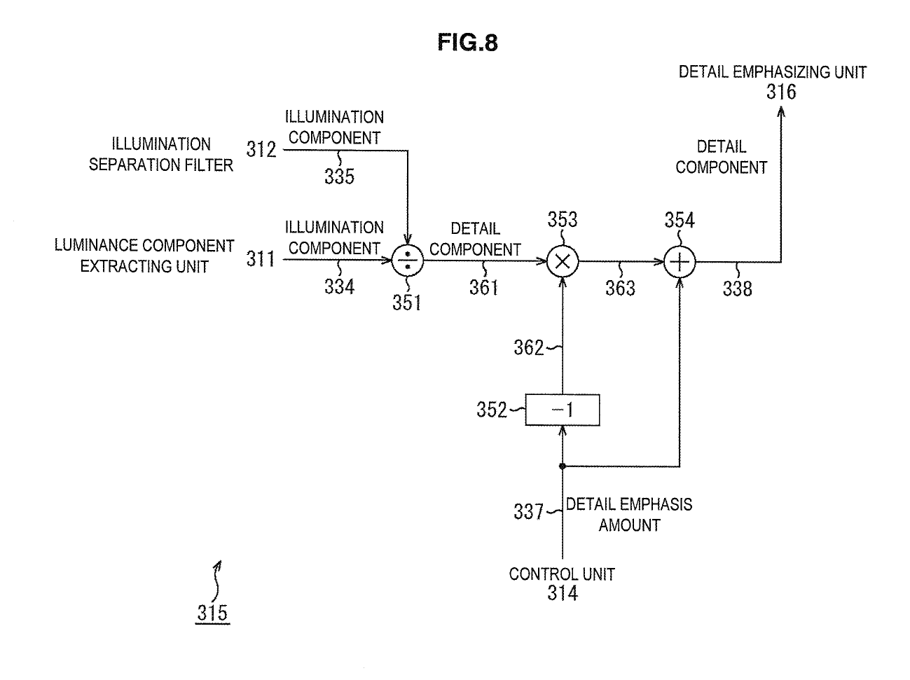

FIG. 8 is a block diagram illustrating an exemplary main configuration of the detail generating unit 315. As shown in FIG. 8, the detail generating unit 315 may include a division unit 351, a subtraction unit 352, a multiplication unit 353, and an addition unit 354.

The division unit 351 may extract the detail component by dividing the luminance component (arrow 334) supplied from the luminance component extracting unit 311 by the illumination component (arrow 335) supplied from the illumination separation filter 312. The division unit 351 may supply the extracted detail component to the multiplication unit 353 (arrow 361).

The subtraction unit 352 may subtract a value “1” from the detail emphasis amount supplied from the control unit 314 to correct the amount which corresponds to a gain value included in the HDR compressed image (arrow 336) already. The subtraction unit 352 may supply the detail emphasis amount from which the value “1” is subtracted to the multiplication unit 353 (arrow 362).

The multiplication unit 353 may multiply the detail component supplied from the division unit 351 by the detail emphasis amount supplied from the subtraction unit 352, and may supply the multiplication result to the addition unit 354 (arrow 363).

The addition unit 354 may add the detail emphasis amount (arrow 337) supplied from the control unit 314 to the multiplication result of the detail component and the detail emphasis amount from which the value “1” is subtracted, supplied from the multiplication unit 353. The addition unit 354 may supply the addition result, i.e., the excessively emphasized detail component, to the detail emphasizing unit 316 (arrow 338).

When the signal precision is rounded during the output of the smoothing filter processing for the purpose of memory reduction, it is desirable to extract the detail component from the signal (luminance component and illumination component) before the rounding. This is because the operation precision is important in the calculation of the detail component.

[Flow of Image Processing]

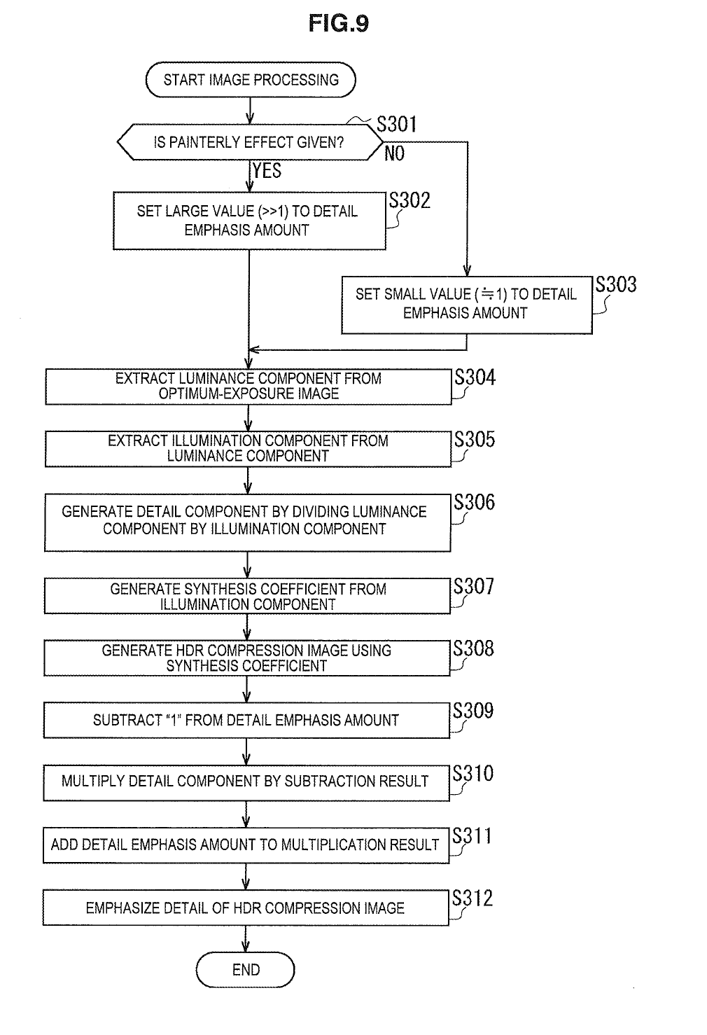

An exemplary image processing flow will be described with reference to the flowchart of FIG. 9.

In step S301, the control unit 314 may determine whether or not to give a painterly effect to an image on which HDR compression processing is performed. If it is determined that the painterly effect is given to the image, the control unit 314 may progress the processing to step S302 and set a large value (sufficiently larger value than 1) to a detail emphasis amount so as to excessively amplify the detail component.

Also, in step S301, if it is determined that the painterly effect is not given to the image, the control unit 314 may progress the processing to step S303 and set a small value (value of approximately 1) to the detail emphasis amount.

In step S302 or S303, when the detail emphasis amount is set, the control unit 314 may progress the processing to step S304.

In step S304, the luminance component extracting unit 311 may extract the luminance component from the optimum-exposure image. In step S305, the illumination separation filter 312 may extract the illumination component from the luminance component extracted in step 304.

In step S306, the division unit 351 of the detail generating unit 315 may extract the detail component by dividing the luminance component extracted in step S304 by the illumination component extracted in step S305.

In step S307, the HDR compression processing unit 313 may generate a combination coefficient from the illumination component extracted in step S305, using, for example, a conversion table. In step S308, the HDR compression processing unit 313 may weight and combine each of the underexposed image, the optimum-exposure image, and the overexposed image such that the deterioration of the image quality such as brightening or darkening does not occur, to generate an HDR compressed image of an appropriate tonal range.

In step S309, the subtraction unit 352 of the detail generating unit 315 may subtract a value “1” from the detail emphasis amount set in step S302 or S303.

In step S310, the multiplication unit 353 of the detail generating unit 315 may multiply the detail component calculated in step S306 by the subtraction result calculated in step S309.

In step S311, the addition unit 354 of the detail generating unit 315 may add the detail emphasis amount set in step S302 or S303 to the multiplication result calculated in step S310.

In step S312, the detail emphasizing unit 316 may emphasize the detail of the HDR compressed image generated in step S308, by multiplying the addition result calculated in step S311. Thus, the HDR image with the detail emphasized in this way may be output to the outside of the image processing apparatus 300, or may be stored in a storage unit (not shown) provided in the image processing apparatus 300.

By performing the above-described image processing, the image processing apparatus 300 can easily combine a plurality of images with different exposure conditions such that the deterioration of the image quality such as brightening or darkening does not occur, and can generate an image with an appropriate tonal range. Also, the image processing apparatus 300 can give the painterly visual effect to the image. The image processing apparatus 300 can give more various effects to the image.

### Fourth Embodiment

[Imaging Device]

The image processing apparatus described above may be configured as a part of other devices, for example, an image processing unit. For example, the image processing apparatus may be configured as an imaging device that captures a subject and generates data of the captured image.

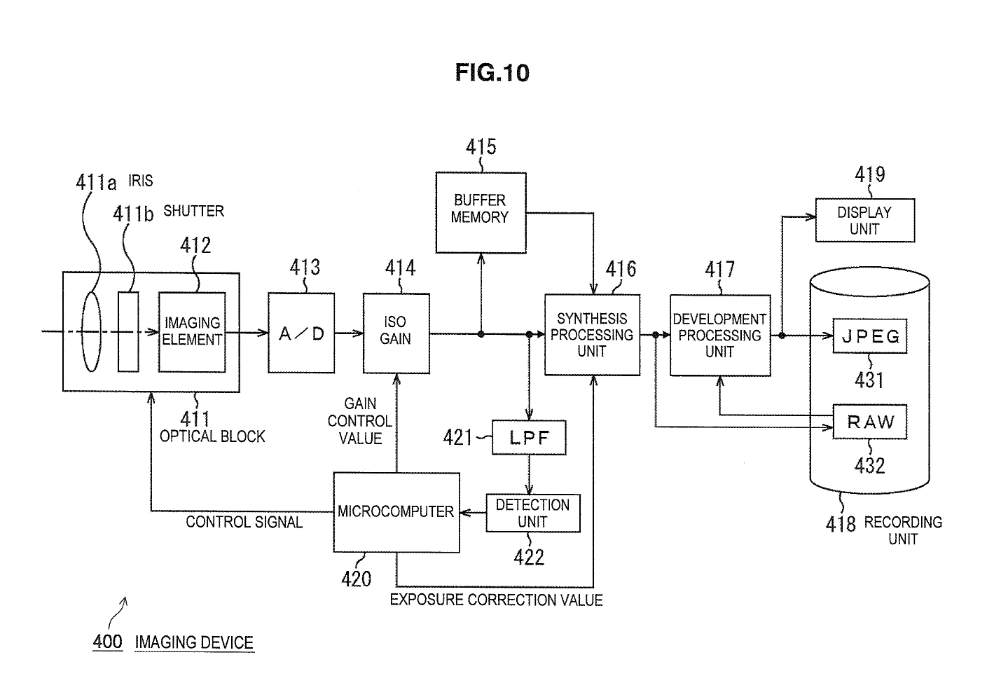

FIG. 10 is a block diagram illustrating an exemplary main configuration of an imaging device. An imaging device 400 shown in FIG. 10 may be a device that captures a subject and generates and outputs the image data of the subject. The imaging device 400 may include the image processing apparatus 100 of FIG. 1, the image processing apparatus 200 of FIG. 5, or the image processing apparatus 300 of FIG. 7 as an image processing unit.

An optical block 411 may include a lens for concentrating light from a subject on an imaging element 412, a driving mechanism (not shown) for executing focusing and zooming by moving the lens, an iris 411a, and a shutter 411b. The driving mechanism in the optical block 411 may be driven according to a control signal from a microcomputer 420. The imaging element 412 may include a Charge Coupled Device (CCD) type image device, a Complementary Metal-Oxide Semiconductor (CMOS) type image device, or the like, and may convert incident light from the subject into electrical signals.

An A/D conversion unit (A/D) 413 may convert image signals output from the imaging element 412 into digital data. An International Organization for Standardization (ISO) gain controlling unit 414 may provide a certain gain with respect to each component of Red, Green and Blue (RGB) of image data from the A/D conversion unit 413 according to gain control values from the microcomputer 420. Also, the adjustment of the ISO gain may be performed in an analog image signal stage prior to input into the A/D conversion unit 413.

A buffer memory 415 may temporarily store a plurality of image data acquired by exposure bracketing that is performed several times with different exposures. A combination processing unit 416 may receive an exposure correction value applied upon exposure bracketing from the microcomputer 420, and may combine a plurality of images in the buffer memory 415 into one image on the basis of the exposure correction value.

A development processing unit 417 may be a block that performs so-called RAW development processing in which RAW image data mainly output from the combination processing unit 416 is converted into visual image data. The development processing unit 417 may perform data interpolation (de-mosaic) processing, various color adjustment/conversion processing (white balance adjustment processing, high-luminance knee compression processing, gamma correction processing, aperture correction processing, and clipping processing), or image compression encoding processing according to a certain encoding method (here, a Joint Photographic Experts Group (JPEG) method is used).

The bit number of RAW image data output from the A/D conversion unit 413 may be 12 bits, and the development processing unit 417 may have specifications for processing 12-bit data. Also, the development processing unit 417 may compress 12-bit data into 8-bit data by the high-luminance knee compression processing (or cutoff of low-order bit) in the development processing procedure, and may perform compression encoding processing with respect to the 8-bit data. Also, the development processing unit 416 may output the 8-bit data on a display unit 419.

A recording unit 418 may be a device for preserving image data acquired by imaging as a data file, and may be realized with portable flash memories and Hard Disk Drives (HDDs). Also, the recording unit 418 may record the RAW image data 432 output from the combination processing unit 416 in addition to JPEG data 431 encoded by the development processing unit 417 as a data file. The RAW image data recorded in the recording unit 418 may be read, processed in the development processing unit 417 and newly recorded as a JPEG data file in the recording unit 418.

The display unit 419 may include a monitor including, for example, a Liquid Crystal Display (LCD). The display unit 419 may generate an image signal for monitor display and supply the image signal to the monitor, based on the uncompressed image data processed in the development processing unit 417. In a preview state of a captured image before recording, captured image signals may be continuously output from the image element 412, and after digital conversion, the digital image data may be supplied to the development processing unit 417 through the ISO gain controlling unit 414 and the combination processing unit 416 to undergo development processing (other than encoding processing). The display unit 419 may display an image (preview image) sequentially output from the development processing unit 417 on the monitor, and then a user can see the preview image with his/her eyes to confirm the view angle.

The microcomputer 420 may include a Central Processing Unit (CPU), a Read Only Memory (ROM), and a Random Access Memory (RAM), and may completely control the imaging device 400 by executing programs stored in the ROM. For example, in this embodiment, an exposure correction value may be calculated based on a detection result from the detection unit 422, and a control signal according to the value may be output to control the iris 411a or the shutter 411b. Thus, automatic exposure (AE) control may be achieved. Also, when wide dynamic range imaging to be described later is performed, the combination processing unit 416 may be notified of the calculated exposure correction value.

A Lowpass Filter (LPF) 421 may perform LPF processing according to necessity with respect to the image data output from the ISO gain controlling unit 414. The detection unit 422 may be a block that performs various detections on the basis of the image data supplied from the ISO gain controlling unit 414 through the LPF 421, and in this embodiment, may divide the image into certain photometric regions and detect luminance values for each photometric region.

In the imaging device 400 described above, an image processing unit having the same configuration and performing the same processing as the image processing apparatus 100 of FIG. 1 or the image processing apparatus 200 of FIG. 5 may be configured as a part or all of the development processing unit 417.

Thus, the development processing unit 417 may easily compress the tonal range of the image data, and may simultaneously give a painterly visual effect to the image.

That is, in the imaging device 400, a plurality of images acquired by exposure bracketing are easily combined, and an image given a painterly visual effect may be acquired. The image may be displayed on the display unit 419 or may be recorded as the JPEG data 431 in the recording unit 418.

The encoding method of the image data recorded in the recording unit 418 may be arbitrarily selected. The recording unit 418 may also store the image data encoded by an encoding method other than JPEG.

An image processing unit having the same configuration and performing the same processing as the image processing apparatus 300 of FIG. 7 may also be configured as a part or all of the combination processing unit 416 and the development processing unit 417.

Thus, the combination processing unit 416 and the development processing unit 417 can easily combine a plurality of images with different exposure conditions such that the deterioration of the image quality such as brightening or darkening does not occur, and can generate an image with an appropriate tonal range. Also, the combination processing unit 416 and the development processing unit 417 can give the painterly visual effect to the image.

### 5. Fifth Embodiment

[Personal Computer]

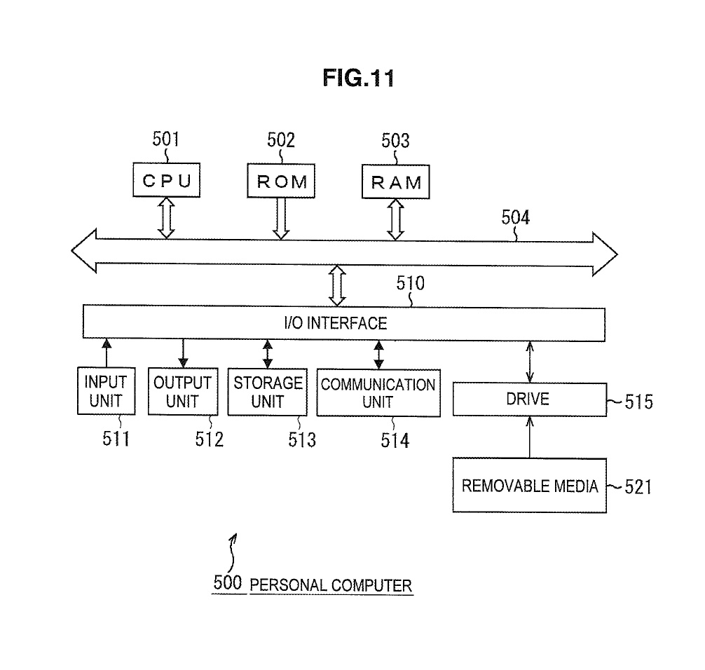

The sequential processing described above may be executed by hardware or software. In this case, a personal computer may be configured as shown in FIG. 11.

In FIG. 11, a Central Processing Unit (CPU) 501 of a personal computer 500 may execute various kinds of processing according to a program stored in a Read Only Memory (ROM) 502, or a program loaded in a Random Access Memory (RAM) 503 from a storage unit 513. Also, data necessary for the CPU 501 to execute various kinds of processing may be appropriately stored in the RAM 503.

The CPU 501, the ROM 502, and the RAM 503 may be connected to each other through a bus 504. Also, the bus 504 may be connected to an input/output (I/O) interface 510.

The I/O interface 510 may be connected to an input unit 511 including a keyboard and a mouse, an output unit 512 including a display such as Cathode Ray Tube (CRT) or Liquid Crystal Display (LCD) and a speaker, the storage unit 513 including a hard disk, and a communication unit 514 including a modem. The communication unit 514 may perform communication processing through a network including Internet.

A drive 515 may be connected to the I/O interface 510 according to necessity, and removable media 521 such as a magnetic disk, an optical disc, a magneto-optical disc, and a semiconductor memory may be appropriately mounted. Computer programs read from the removable media 521 may be installed in the storage unit 513 according to necessity.

When the sequential processing is executed by software, programs constituting the software may be installed from a network or a recording medium.

As shown in FIG. 11, the recording media may be configured in the removable media 521 including magnetic disks (including flexible disks), optical discs (including a Compact Disc-Read Only Memory (CD-ROM) and a Digital Versatile Disc (DVD)), magneto-optical discs (including a Mini Disc (MD)), or semiconductor memories, on which programs are recorded to be distributed to a user independently of the main body of the device. Also, the recording media may be configured in the ROM 502 on which programs are recorded and delivered to a user in a state of being pre-assembled in the main body of the device or a hard disk included in the storage unit 513.

Programs executed by a computer may be performed in time-series according to the description order of the present disclosure, or may be performed in parallel or at necessary timings when called.

In the present disclosure, steps of describing programs recorded in recording media may include processing performed in time-series according to the description order and processing not processed in time-series but performed in parallel or individually.

In the present disclosure, a system may represent the whole of a device configured by a plurality of devices.

Also, the configuration described above as one device (or processing unit) may be divided into a plurality of devices (or processing units). On the other hand, the configuration described above as a plurality of devices (or processing units) may be integrated into one device. Also, other components may be added to the configuration of each device (or each processing unit). As long as the configuration or operation of the system is substantially similar as a whole, a part of the configuration of any device (or processing unit) may also be allowed to be included in other devices (or other processing units). The embodiments of the present disclosure are not limited to the above-mentioned embodiments, but can be variously modified within the scope of the present disclosure.

Also, the present technology may be configured as follows.

(1) An image processing apparatus including:

a control unit configured to control whether or not to set an amplification factor for amplifying a reflectance component of an image to a large enough value to give a painterly visual effect to the image;

a separation unit configured to separate the image into an illumination component and the reflectance component;

an amplification unit configured to amplify the reflectance component separated by the separation unit with the amplification factor controlled by the control unit; and

a combination unit configured to combine the illumination component separated by the separation unit and the reflectance component amplified by the amplification unit.

(2) The image processing apparatus according to (1), further including a tone compressing unit configured to compress a tone of the illumination component separated by the separation unit,

wherein the separation unit separates an image with a wide tonal range into the illumination component and the reflectance component, and the combination unit generates an image with an optimized tonal range, by combining the illumination component with a tone compressed by the tone compressing unit and the reflectance component amplified by the amplification unit.

(3) The image processing apparatus according to (2), further including a tone extending unit configured to extend a tone of the reflectance component separated by the separation unit with respect to the tone compression by the tone compressing unit,

wherein the amplification amplifies the reflectance component with the tone extended by the tone extending unit with an amplification factor controlled by the control unit.

(4) The image processing apparatus according to (2), further including a gain combination unit configured to generate a combined gain by combining an amplification factor corresponding to the tone compression of the tone compressing unit to extend the tone of the reflectance component separated by the separation unit and the amplification factor controlled by the control unit,

wherein the amplification unit amplifies the reflectance component separated by the separation unit with the combined gain generated by the gain combination unit.

(5) The image processing apparatus according to (1), further including an image generating unit configured to generate an image with an appropriate tonal range, by combining a plurality of images with different exposure conditions by weighting the illumination component separated by the separation unit,

wherein the combination unit combines the image, which is generated by the image generating unit and includes the illumination component separated by the separation unit as a component, with the reflectance component amplified by the amplification unit.

(6) The image processing apparatus according to any one of (1) to (5), wherein the control unit sets the amplification factor to a larger value when giving a painterly visual effect to the image, and sets the amplification factor to a smaller value when not giving the painterly visual effect to the image.

(7) The image processing apparatus according to any one of (1) to (6), wherein the control unit sets a value in accordance with a luminance value of a pixel as the amplification factor.

(8) The image processing apparatus according to any one of (1) to (7), wherein the control unit sets a value in accordance with a region as the amplification factor.

(9) The image processing apparatus according to any one of (1) to (8), wherein the separation unit separates the image into the illumination component and the reflectance component using an edge preserving smoothing filter.

(10) The image processing apparatus according to any one of (1) to (9), wherein the separation unit includes:

an illumination component extracting unit configured to extract the illumination component from the image; and

a reflectance component extracting unit configured to extract the reflectance component using the image and the illumination component extracted by the illumination component extracting unit.

(11) The image processing apparatus according to (10), wherein:

the separation unit further includes a luminance component extracting unit configured to extract a luminance component from the image;

the illumination component extracting unit extracts the illumination component from the luminance component extracted by the luminance component extracting unit; and

the reflectance component extracting unit extracts the reflectance component using the luminance component extracted by the luminance component extracting unit and the illumination component extracted by the illumination component extracting unit.

(12) The image processing apparatus according to (10) or (11), wherein the illumination component extracting unit rounds the extracted illumination component, and the reflectance component extracting unit extracts the reflectance component using the illumination component extracted by the illumination component extracting unit prior the rounding.

(13) An image processing method including:

controlling whether or not to set an amplification factor for amplifying a reflectance component of an image to a large value enough to give a painterly visual effect to the image;

separating the image into an illumination component and the reflectance component;

amplifying the separated reflectance component with the amplification factor; and

combining the separated illumination component and the amplified reflectance component.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2011-117467 filed in the Japan Patent Office on May 25, 2011, the entire content of which is hereby incorporated by reference.

What is claimed is:

1. An image processing apparatus comprising:
a control unit configured to control whether or not to set an amplification factor for amplifying a reflectance component of an image to a large enough value to give a painterly visual effect to the image;
a separation unit configured to separate the image into an illumination component and the reflectance component;
an amplification unit configured to amplify the reflectance component separated by the separation unit with the amplification factor controlled by the control unit; and
a combination unit configured to combine the illumination component separated by the separation unit and the reflectance component amplified by the amplification unit.

2. The image processing apparatus according to claim 1, further comprising a tone compressing unit configured to compress a tone of the illumination component separated by the separation unit,
wherein the separation unit separates an image with a wide tonal range into the illumination component and the reflectance component, and the combination unit generates an image with an optimized tonal range, by combining the illumination component with a tone compressed by the tone compressing unit and the reflectance component amplified by the amplification unit.

3. The image processing apparatus according to claim 2, further comprising a tone extending unit configured to extend a tone of the reflectance component separated by the separation unit with respect to the tone compression by the tone compressing unit,
wherein the amplification amplifies the reflectance component with the tone extended by the tone extending unit with an amplification factor controlled by the control unit.

4. The image processing apparatus according to claim 2, further comprising a gain combination unit configured to generate a combined gain by combining an amplification factor corresponding to the tone compression of the tone compressing unit to extend the tone of the reflectance component separated by the separation unit and the amplification factor controlled by the control unit,
wherein the amplification unit amplifies the reflectance component separated by the separation unit with the combined gain generated by the gain combination unit.

5. The image processing apparatus according to claim 1, further comprising an image generating unit configured to generate an image with an appropriate tonal range, by combining a plurality of images with different exposure conditions by weighting the illumination component separated by the separation unit,
wherein the combination unit combines the image, which is generated by the image generating unit and includes the illumination component separated by the separation unit as a component, with the reflectance component amplified by the amplification unit.

6. The image processing apparatus according to claim 1, wherein the control unit sets the amplification factor to a larger value when giving a painterly visual effect to the image, and sets the amplification factor to a smaller value when not giving the painterly visual effect to the image.

7. The image processing apparatus according to claim 1, wherein the control unit sets a value in accordance with a luminance value of a pixel as the amplification factor.

8. The image processing apparatus according to claim 1, wherein the control unit sets a value in accordance with a region as the amplification factor.

9. The image processing apparatus according to claim 1, wherein the separation unit separates the image into the illumination component and the reflectance component using an edge preserving smoothing filter.

10. The image processing apparatus according to claim 1, wherein the separation unit comprises:
an illumination component extracting unit configured to extract the illumination component from the image; and
a reflectance component extracting unit configured to extract the reflectance component using the image and the illumination component extracted by the illumination component extracting unit.

11. The image processing apparatus according to claim 10, wherein:
the separation unit further comprises a luminance component extracting unit configured to extract a luminance component from the image;
the illumination component extracting unit extracts the illumination component from the luminance component extracted by the luminance component extracting unit; and
the reflectance component extracting unit extracts the reflectance component using the luminance component extracted by the luminance component extracting unit and the illumination component extracted by the illumination component extracting unit.

12. The image processing apparatus according to claim 10, wherein the illumination component extracting unit rounds the extracted illumination component, and the reflectance component extracting unit extracts the reflectance component using the illumination component extracted by the illumination component extracting unit prior to the rounding.

13. An image processing method comprising:
controlling whether or not to set an amplification factor for amplifying a reflectance component of an image to a large enough value to give a painterly visual effect to the image;
separating the image into an illumination component and the reflectance component;
amplifying the separated reflectance component with the amplification factor; and
combining the separated illumination component and the amplified reflectance component.
